(19) United States
(12) Patent Application Publication
(10) Pub. No.: US 2026/0227737 A1
(43) Pub. Date: Aug. 6, 2026

(54) IMAGE FORMING APPARATUS WITH FOLLOWER ROLLING ELEMENT CAPABLE OF RETAINING CONSTANT DISTANCE BETWEEN SHEET TRAVELLING IN DIRECTION OF SHEET CONVEYANCE AND STATIC ELIMINATING SHEET

(71) Applicant: KYOCERA Document Solutions Inc., Osaka (JP)

(72) Inventors: Takuro MORITA, Osaka (JP); Takehiro SATO, Osaka (JP); Masayuki YAMADA, Osaka (JP)

(73) Assignee: KYOCERA Document Solutions Inc., Osaka (JP)

(21) Appl. No.: 19/530,574

(22) Filed: Feb. 5, 2026

(30) Foreign Application Priority Data
Feb. 6, 2025 (JP) 2025-018287

(51) Int. Cl. G03G 15/00; G03G 15/16; G03G 15/01

(52) U.S. Cl. CPC G03G 15/657; G03G 15/1615; G03G 15/0131; G03G 15/0189; G03G 2215/00679

(57) ABSTRACT

The static eliminator and the first guide are provided downstream of the transfer nip in a direction of conveyance of the sheet, and on the same side as the transfer roller opposite to the drive roller. The follower rolling element is supported by the first guide to locate downstream of the static eliminator in the direction of conveyance of the sheet and allow for driven rotation. The follower rolling element is disposed with a center of rotation thereof located on the same side as the transfer roller with respect to an imaginary travel line on which a leading edge of the sheet having passed through the transfer nip is assumed to travel under assumption of absence of the follower rolling element and with a rotating surface of the follower rolling element projecting to the same side as the drive roller beyond the imaginary travel line.

### INCORPORATION BY REFERENCE

This application claims priority to Japanese Patent Application No. 2025-018287 filed on February 6, 2025, the entire contents of which are incorporated by reference herein.

### BACKGROUND

The present disclosure relates to image forming apparatuses and particularly relates to a technique for eliminating static electricity from a sheet with a toner image secondarily transferred thereto.

An electrophotographic image forming apparatus is widely known in which a toner image on the surface of a photosensitive drum is primarily transferred to the surface of an intermediate transfer belt and the toner image on the surface of the intermediate transfer belt is secondarily transferred to a sheet.

In such an image forming apparatus, the sheet may become electrostatically charged in the process of the secondary transfer. If the amount of electrostatic charge on the sheet is large, there arises a problem that the sheet cannot stably be conveyed, for example, due to sticking of the sheet to a guide provided between a transfer nip where the secondary transfer is made and a fixing device, or worse may be twisted to cause image defects or become wrinkled.

As a solution to this problem, for example, there is known a general technique in which a static eliminating sheet is disposed downstream of the secondary transfer nip in the direction of sheet conveyance to make its lengthwise direction parallel to the axial direction of a secondary transfer roller and the orientation of the static eliminating sheet in its widthwise direction is adjusted according to the polarity of the electrostatically charged sheet.

### SUMMARY

A technique improved over the aforementioned technique is proposed as one aspect of the present disclosure.

An image forming apparatus according to an aspect of the present disclosure includes an endless intermediate transfer belt, a drive roller, a transfer roller, a static eliminator, a first guide, and a follower rolling element. The endless intermediate transfer belt allows a toner image to be transferred to a surface thereof. The drive roller comes into contact with a reverse surface of the intermediate transfer belt to drive the intermediate transfer belt into rotation. The transfer roller is opposed to the drive roller with the intermediate transfer belt in between to form a transfer nip where a sheet is to be nipped and conveyed. The static eliminator is provided downstream of the transfer nip in a direction of conveyance of the sheet and on the same side as the transfer roller opposite to the drive roller with respect to the direction of conveyance of the sheet. The first guide is provided downstream of the transfer nip in the direction of conveyance of the sheet and includes a guide surface located on the same side as the transfer roller with respect to the direction of conveyance of the sheet to extend along the direction of conveyance of the sheet. The follower rolling element is supported by the first guide to locate downstream of the static eliminator in the direction of conveyance of the sheet and allow for driven rotation. The follower rolling element is disposed with a center of rotation thereof located on the same side as the transfer roller with respect to an imaginary travel line on which a leading edge of the sheet having passed through the transfer nip is assumed to travel under assumption of absence of the follower rolling element and with a rotating surface of the follower rolling element projecting to the same side as the drive roller beyond the imaginary travel line.

### BRIEF DESCRIPTION OF THE DRAWINGS

FIG. 1 is a frontal cross-sectional view showing the structure of an image forming apparatus.

FIG. 2 is a block diagram showing an electrical configuration of the image forming apparatus.

FIG. 3 is a partly enlarged view of an image forming device, a fixing device, and the vicinity of them.

FIG. 4 is a view schematically showing the location where a follower rolling element is disposed.

FIG. 5 is a view schematically showing where the follower rolling element is located with respect to the direction of sheet conveyance.

FIG. 6 is a view showing the distance from the leading edge of a sheet to an image forming region thereof.

FIG. 7 is a view showing a follower rolling element according to a first modification.

FIG. 8 is a view schematically showing the location where the follower rolling element according to the first modification is disposed.

### DETAILED DESCRIPTION

Hereinafter, a description will be given of an image forming apparatus according to an embodiment of the present disclosure with reference to the drawings.

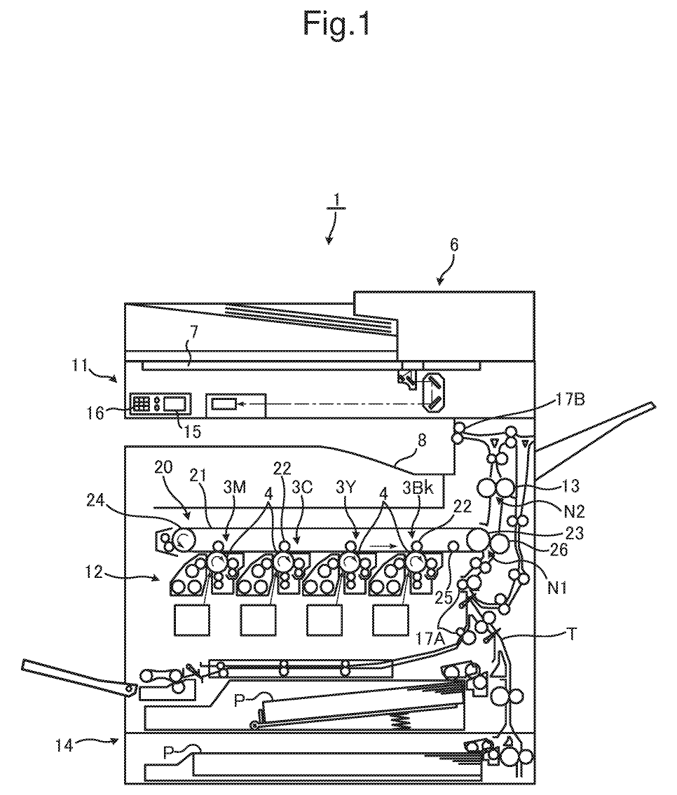

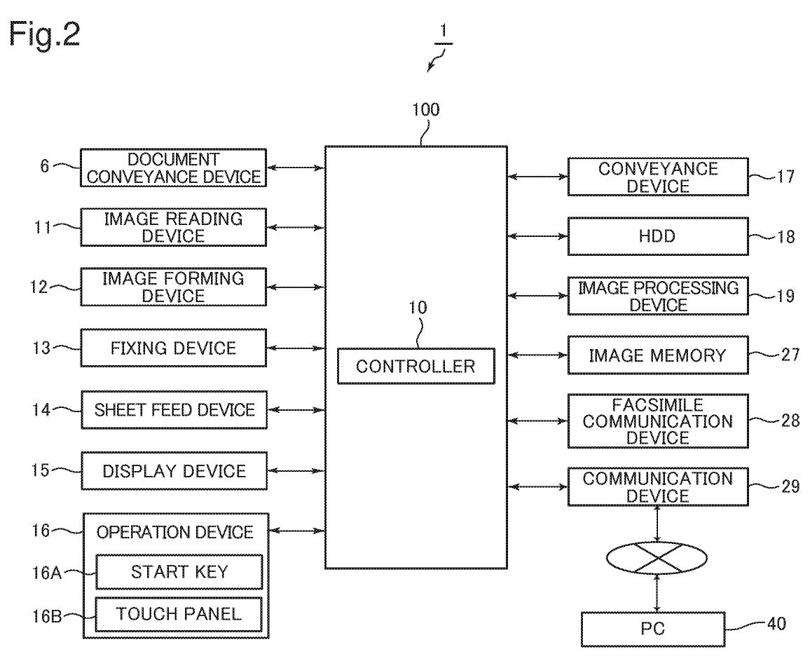

FIG. 1 is a frontal cross-sectional view showing the structure of an image forming apparatus 1 according to one embodiment of the present disclosure. FIG. 2 is a block diagram showing an electrical configuration of the image forming apparatus 1. Referring to FIGS. 1 and 2, the image forming apparatus 1 is a multifunction peripheral having multiple functions, such as a copy function, a transmission function, a print function, and a facsimile function.

The image forming apparatus 1 includes a document conveyance device 6, an image reading device 11, an image forming device 12, a fixing device 13, a sheet feed device 14, a display device 15, an operation device 16, and a conveyance device 17.

The document conveyance device 6 conveys sheets of original document placed on a document loading table sheet by sheet to a reading position of the image reading device 11.

The image reading device 11 reads a sheet of original document conveyed by the document conveyance device 6 or a sheet of original document placed on an original glass plate 7 and generates image data representing the image of the sheet of original document.

The image forming device 12 forms a toner image on a sheet P based on the image represented by the image data. The image forming device 12 includes an image forming unit 3M for magenta, an image forming unit 3C for cyan, an image forming unit 3Y for yellow, and an image forming unit 3Bk for black.

Each of the image forming units 3M, 3C, 3Y, and 3Bk includes a photosensitive drum 4 as an image carrier, a charging device, an exposure device, and a developing device. The charging device charges the surface of the photosensitive drum 4 uniformly. The exposure device exposes the surface of the photosensitive drum 4 to light to form an electrostatic latent image on the surface of the photosensitive drum 4. The developing device develops the electrostatic latent image on the surface of the photosensitive drum 4 into a toner image.

The image forming device 12 further includes an intermediate transfer unit 20. The intermediate transfer unit 20 includes an intermediate transfer belt 21, four primary transfer rollers 22, a drive roller 23, a tension roller 24, and a support roller 25.

The intermediate transfer belt 21 is an endless belt to the surface of which a toner image is to be transferred. The intermediate transfer belt 21 is mounted around the four primary transfer rollers 22, the drive roller 23, the tension roller 24, and the support roller 25.

The drive roller 23 comes into contact with the reverse surface of the intermediate transfer belt 21 to drive the intermediate transfer belt 21 into rotation. In other words, the intermediate transfer belt 21 is driven by the drive roller 23 and thus travel in a loop around the rollers. The drive roller 23 is a cylindrical roller extending in a widthwise direction of a sheet to be conveyed, that is, in a widthwise direction of the intermediate transfer belt 21 orthogonal to the direction of travel of the belt and is provided with a length equal to or longer than the width of the intermediate transfer belt 21.

The four primary transfer rollers 22 are pressed, through the intermediate transfer belt 21, against the respective photosensitive drums 4 of the image forming units 3M, 3C, 3Y, and 3Bk. When the drive roller 23 is driven into rotation, the intermediate transfer belt 21 comes into contact with the four photosensitive drums 4 while traveling in a loop and, as a result, toner images of four colors are primarily transferred from the photosensitive drums 4 to the intermediate transfer belt 21 and thus superimposed on each other.

The image forming device 12 further includes a secondary transfer roller 26. The secondary transfer roller 26 is opposed to the drive roller 23 with the intermediate transfer belt 21 in between to form a transfer nip N1 where a sheet P is to be nipped and conveyed. A multicolor toner image formed on the surface of the intermediate transfer belt 21 is secondarily transferred, at the transfer nip N1, to a sheet P being conveyed through a conveyance path T from the sheet feed device 14. The secondary transfer roller 26 is a cylindrical roller extending in the same direction as the drive roller 23 and is provided with a length as long as the drive roller 23.

The fixing device 13 includes: a fixing roller internally provided with a heater; and a pressure roller that presses against the fixing roller. The fixing device 13 applies, at a fixing nip N2 formed between the fixing roller and the pressure roller, heat and pressure to the sheet P with the toner image secondarily transferred thereto, thus fixing the toner image to the sheet P. The sheet P with the toner image fixed thereto and an image thus formed thereon is ejected to a sheet output tray 8.

The sheet feed device 14 includes a manual feed tray and a plurality of sheet feed cassettes. The sheet feed device 14 pulls out sheets P contained in either one of the plurality of sheet feed cassettes or sheets placed on the manual feed tray sheet by sheet with a pick-up roller and feeds forward the pulled-out sheet to the sheet conveyance path T. The type of sheet P for use is not limited to a paper sheet and may be, for example, an OHP (overhead projector) sheet.

The display device 15 is, for example, a liquid crystal display or an organic EL (an organic light-emitting diode) display. The display device 15 displays various screens.

The operation device 16 includes a plurality of hardware keys, including a start key 16A for use in inputting an instruction to start execution of copy processing, scan processing, and so on. The operation device 16 further includes a touch panel 16B superposed on the display device 15. The operation device 16 accepts an input of a user's instruction.

The conveyance device 17 includes conveyance roller pairs 17A, an ejection roller pair 17B, other like rollers, and a conveyance motor. When the conveyance roller pairs 17A, the ejection roller pair 17B, and so on are rotated by the drive of the conveyance motor, the sheet P fed forward by the sheet feed device 14 is conveyed along the conveyance path T.

Referring to FIG. 2, the image forming apparatus 1 further includes a control device 100, an HDD (hard disk drive) 18, an image processing device 19, an image memory 27, a facsimile communication device 28, and a communication device 29.

The control device 100 includes a processor, a RAM (random access memory), a ROM (read only memory), and so on. The processor is, for example, a CPU (central processing unit), an MPU (micro processing unit) or an ASIC (application specific integrated circuit).

When a control program stored in the ROM or the HDD 18 is executed by the above processor, the control device 100 functions as a controller 10. The controller 10 controls the respective operations of devices constituting the image forming apparatus 1. Alternatively, the controller 10 may not be implemented by the operation of the processor in accordance with the control program, but may instead be constituted by a logic circuit equivalent to the control program.

The control device 100 is electrically connected to the document conveyance device 6, the image reading device 11, the image forming device 12, the fixing device 13, the sheet feed device 14, the display device 15, the operation device 16, the conveyance device 17, the HDD 18, the image processing device 19, the image memory 27, the facsimile communication device 28, the communication device 29, and so on.

The HDD 18 is a large-capacity storage device for use in storing various types of data. The HDD 18 stores various types of control programs for use in implementing general operations of the image forming apparatus 1.

The image processing device 19 performs, as necessary, image processing of image data generated by the image reading device 11. The image memory 27 temporarily stores image data generated by the image reading device 11. The facsimile communication device 28 transfers image data to and from other facsimile devices via the public line.

The communication device 29 includes a communication module, such as a LAN (local area network) board. The controller 10 performs data communications through the communication device 29 with external devices, such as a PC (personal computer) 40, connected thereto via a network.

Each of the devices constituting the image forming apparatus 1 is connected to a power supply. When the image forming apparatus 1 is powered on by the user, electric power is supplied from the power supply to each of the devices of the image forming apparatus 1.

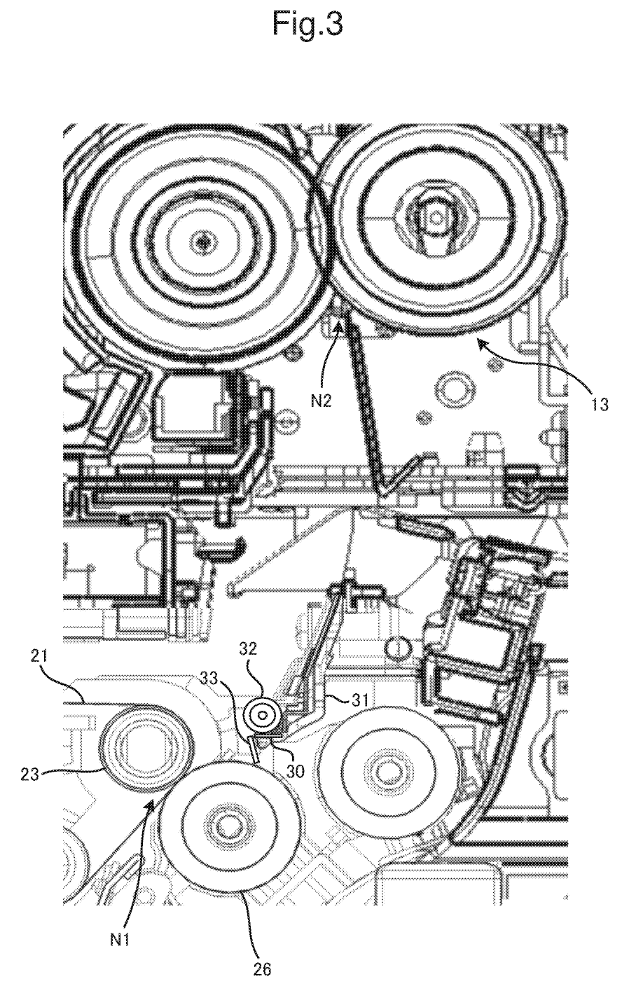

FIG. 3 is a partly enlarged view of the image forming device 12, the fixing device 13, and the vicinity of them. Referring to FIG. 3, the image forming apparatus 1 further includes a static eliminator 30, a first guide 31, a follower rolling element 32, and a second guide 33.

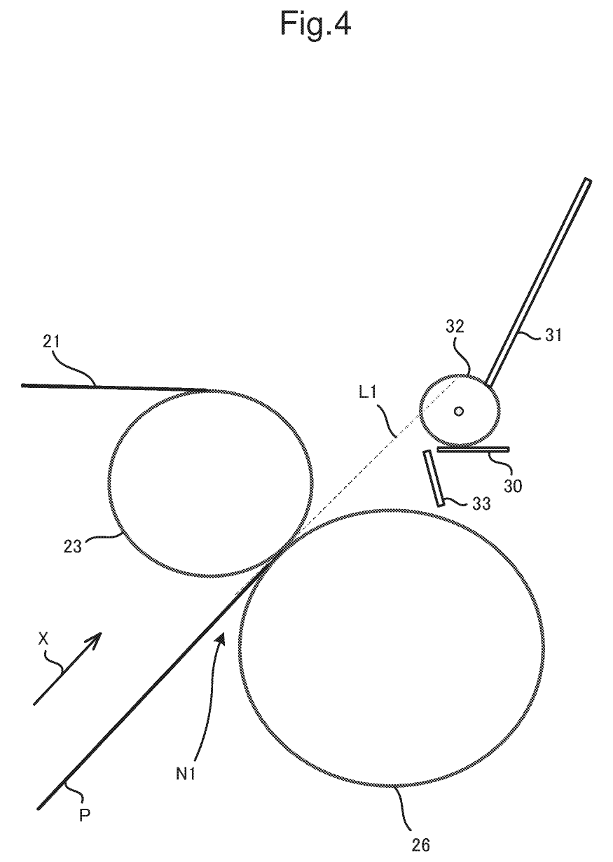

The static eliminator 30 is provided downstream of the transfer nip N1 in the direction X of sheet conveyance (the direction in which the sheet is conveyed forward, see FIG. 4) and on the same side as the secondary transfer roller 26 opposite to the drive roller 23 with respect to the direction of sheet conveyance. The static eliminator 30 is an electrically conductive sheet extending in a direction of extension of the secondary transfer roller 26 and the drive roller 23 and made of, for example, stainless steel. An edge of the static eliminator 30 located at one end in the widthwise direction of the static eliminator 30 and near the traveling sheet P is processed into a saw-toothed edge. The sawtooth pitch is, for example, 1mm.

The static eliminator 30 is disposed with its lengthwise direction parallel to the axis of the secondary transfer roller 26 and the tips of the sawteeth oriented to the transfer nip N1. The static eliminator 30 is earthed.

The sheet P to which a toner image has been secondarily transferred and which has thus been charged with static electricity passes through the transfer nip N1 and then travels near the static eliminator 30. In doing so, an ion flux is generated between each of the tips of the sawteeth of the static eliminator 30 and the electrostatically charged sheet P and, thus, charges migrate from the charged sheet P toward the static eliminator 30. In this manner, static electricity is eliminated from the sheet P.

The first guide 31 is provided downstream of the transfer nip N1 in the direction X of sheet conveyance and on the same side as the secondary transfer roller 26 opposite to the drive roller 23 with respect to the direction X of sheet conveyance. The first guide 31 includes a guide surface extending along the direction X of sheet conveyance. The first guide 31 guides the sheet P having passed through the transfer nip N1 toward the fixing nip N2 with the guide surface as a guide.

The follower rolling element 32 is a follower roller supported by the first guide 31 to locate downstream of the static eliminator 30 in the direction X of sheet conveyance and allow for driven rotation. In this embodiment, the follower rolling element 32 is formed to have a circular profile when viewed from its axial direction. The follower rolling element 32 rotates by making contact with a sheet P that has passed through the transfer nip N1 and is being conveyed toward the fixing nip N2 and following the traveling movement of the sheet P.

The follower rolling element 32 is provided in the direction of extension of the secondary transfer roller 26 and the drive roller 23, for example, over a length as long as the width of the intermediate transfer belt 21 and constituted by a cylindrical roller having the above length or a plurality of cylindrical rollers arranged spaced-apart over the length as long as the width of the intermediate transfer belt 21 on a rotating shaft extending in the above direction of extension.

The second guide 33 is an insulating member (for example, a plate-like member or a sheet member) provided to partition the space between the static eliminator 30 and the secondary transfer roller 26. The second guide 33 is made of, for example, PET (polyethylene terephthalate).

FIG. 4 is a view schematically showing the location where the follower rolling element 32 is disposed. With reference to FIG. 4, the follower rolling element 32 is disposed with the central axis of rotation thereof located on the same side as the secondary transfer roller 26 with respect to an imaginary travel line L1 on which the leading edge of a sheet P having passed through the transfer nip N1 is assumed to travel under assumption of absence of the follower rolling element 32 and with the rotating surface of the follower rolling element 32 projecting to the same side as the drive roller 23 beyond the imaginary travel line L1.

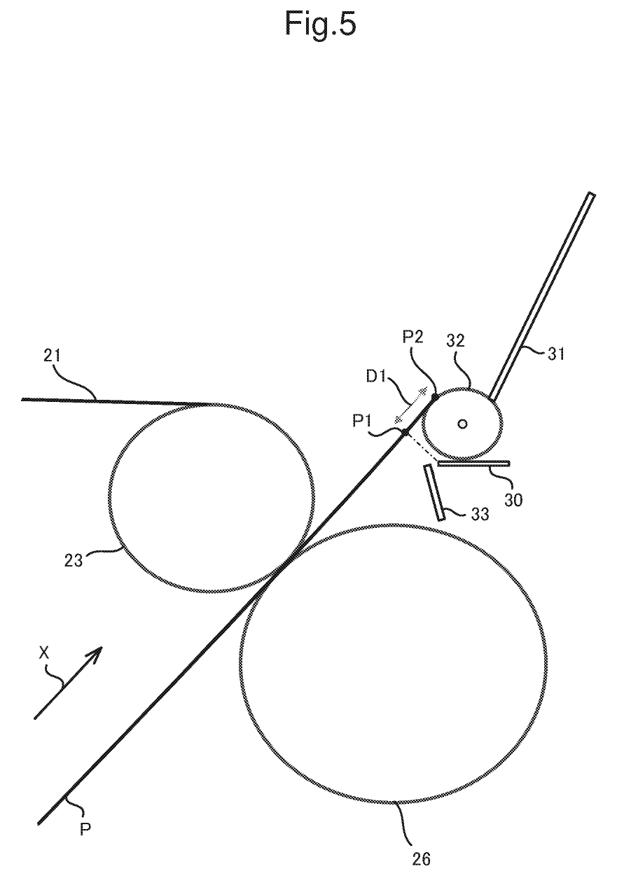

FIG. 5 is a view schematically showing where the follower rolling element 32 is located with respect to the direction X of sheet conveyance. In FIG. 5, the distance D1 represents the distance from an intersection point P1 between the sheet P traveling in the direction X of sheet conveyance and the perpendicular line from the tip of the sawtooth of the static eliminator 30 to the traveling sheet P to a contact point P2 between the leading edge of the sheet P traveling in the direction X of sheet conveyance and the follower rolling element 32.

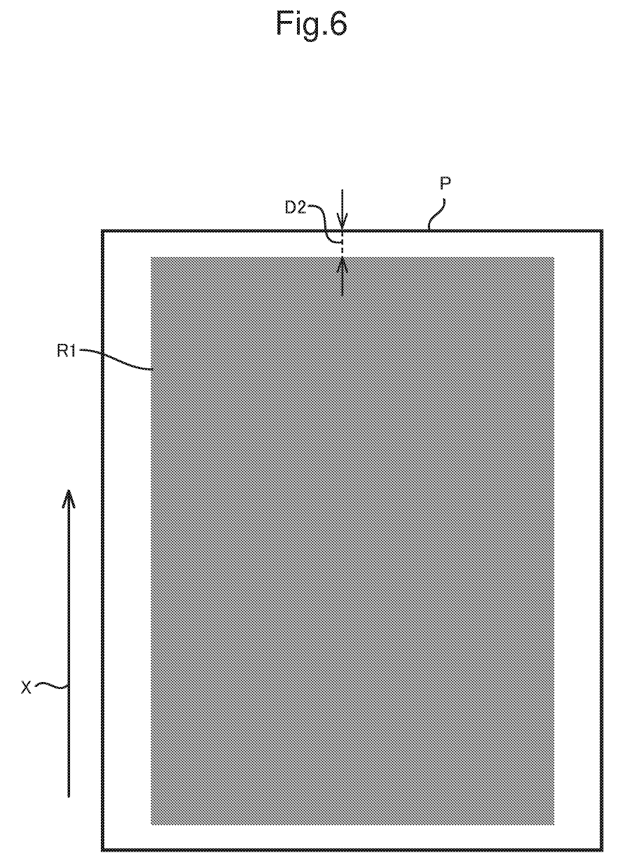

FIG. 6 is a view showing the distance D2 from the leading edge of a sheet to an image forming region R thereof. In FIG. 6, the distance D2 represents the distance from the leading edge of a sheet P traveling in the direction X of sheet conveyance to a region R where a toner image secondarily transferred to the sheet P is to be formed (hereinafter, referred to as an "image forming region"). In this embodiment, the location of the follower rolling element 32 in the direction X of sheet conveyance is selected to make the distance D1 shorter than the distance D2.

In the general technique described previously, since the distance between the sheet traveling in the direction of sheet conveyance and the static eliminating sheet is not constantly retained at a suitable distance, the sheet cannot stably be conveyed and, thus, static elimination from the sheet may become unstable. In addition, since the structure for controlling the orientation of the widthwise direction of the static eliminating sheet is employed, its structure is complicated, which may increase the cost.

Unlike the general technique, in the above embodiment, the follower rolling element 32 is disposed with the central axis of rotation thereof located on the same side as the secondary transfer roller 26 with respect to an imaginary travel line L1 on which the leading edge of a sheet P having passed through the transfer nip N1 is assumed to travel under assumption of absence of the follower rolling element 32 and with the rotating surface of the follower rolling element 32 projecting to the same side as the drive roller 23 beyond the imaginary travel line L1.

Therefore, the follower rolling element 32 comes into contact with the sheet P traveling in the direction X of sheet conveyance to support the traveling sheet P and restrict the direction of travel of the sheet P and thus enables the distance between the static eliminator 30 and the traveling sheet P to be retained constantly at a suitable distance. As a result, static electricity can be stably eliminated from the sheet P. Furthermore, the amount of deflection of the sheet P when having reached the fixing nip N2 can be retained at a constant amount. As a result, the sheet P can be stably conveyed. Accordingly, the conveyance and static elimination of the sheet can be stably achieved with a simple structure.

In addition, in the above embodiment, the distance D1 from an intersection point P1 between the sheet P traveling in the direction X of sheet conveyance and the perpendicular line from the saw-toothed edge of the static eliminator 30 near the traveling sheet P to the traveling sheet P to a contact point P2 between the leading edge of the sheet P traveling in the direction X of sheet conveyance and the follower rolling element 32 is shorter than the distance D2 from the leading edge of the sheet P traveling in the direction X of sheet conveyance to the image forming region R of the sheet P.

Therefore, the posture of the traveling sheet P becomes stable before the image forming region R of the sheet P traveling in the direction X of sheet conveyance passes near the static eliminator 30, which enables a constant distance between the static eliminator 30 and the traveling sheet P to be surely retained. As a result, static electricity can be surely and stably eliminated from the sheet P.

In the above embodiment, the image forming apparatus 1 further includes the insulating second guide 33 provided between the static eliminator 30 and the secondary transfer roller 26.

Since, as just described, the second guide 33 is provided to partition the space between the static eliminator 30 and the secondary transfer roller 26, it can be prevented that the sheet P traveling in the direction X of sheet conveyance travels toward the static eliminator 30. In addition, a high voltage can be prevented from leaking between the static eliminator 30 and the secondary transfer roller 26.

### First Modification

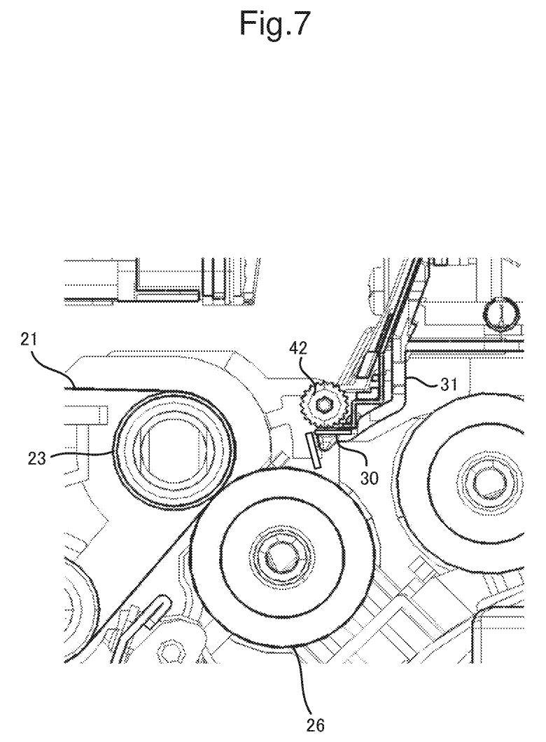

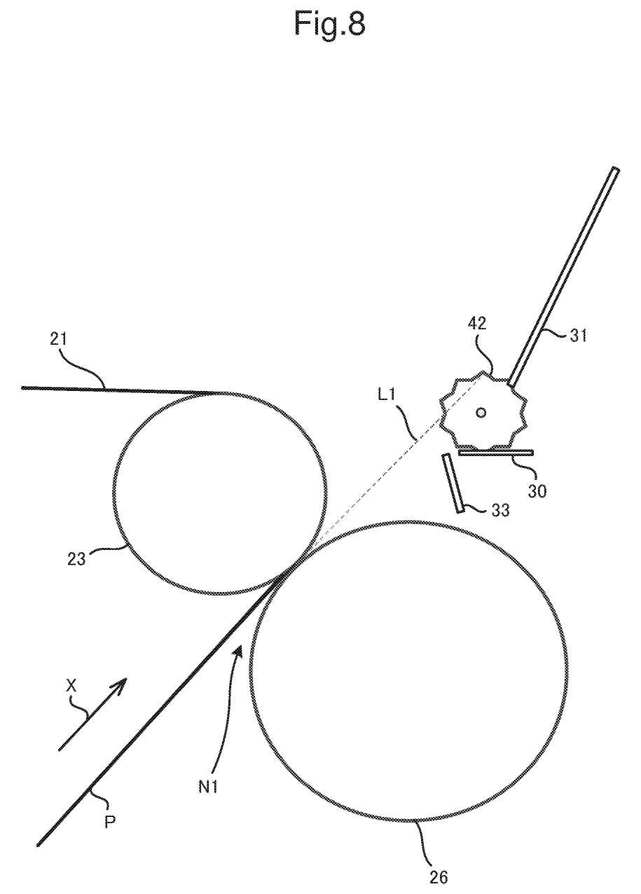

Although in the above embodiment the follower rolling element 32 is formed to have a circular profile when viewed from its axial direction, the present disclosure is not limited to the above embodiment. FIG. 7 is a view showing a follower rolling element 42 according to a first modification of the above embodiment. FIG. 8 is a view schematically showing the location where the follower rolling element 42 is disposed.

As shown in FIG. 7, the follower rolling element 42 according to the first modification is formed to have a wavy circular profile (for example, a star-like profile or a multi-angular profile) in which a plurality of projections are closely arranged on a cylindrical outer periphery of the follower rolling element 42 when viewed from its axial direction. Specifically, a plurality of elongated teeth extending in the axial direction are radially formed as the above-described projections at regular intervals along the outer periphery of the follower rolling element 42.

With reference to FIG. 8, like the follower rolling element 32 in the above embodiment, the follower rolling element 42 is disposed with the central axis of rotation thereof located on the same side as the secondary transfer roller 26 with respect to an imaginary travel line L1 on which the leading edge of a sheet P having passed through the transfer nip N1 is assumed to travel under assumption of absence of the follower rolling element 42 and with the rotating surface of the follower rolling element 42 projecting to the same side as the drive roller 23 beyond the imaginary travel line L1.

In the first modification, since the follower rolling element 42 has a wavy circular profile in which a plurality of projections are closely arranged on the outer periphery of the follower rolling element 42, the leading edge of the sheet P traveling in the direction of sheet conveyance hits any one of the flanks of the projections forming the wavy circular profile, which enables easy rotation of the follower rolling element 42.

### Other Modifications

Although in the above embodiment a multifunction peripheral is used as the image forming apparatus 1, this is merely illustrative and other types of image forming apparatuses, including a printer, a copier, and a facsimile device, may be used.

The structure and configuration of the above embodiment described with reference to FIGS. 1 to 8 are merely illustrative of the present disclosure and are not intended to limit the present disclosure to them.

While the present disclosure has been described in detail with reference to the embodiments thereof, it would be apparent to those skilled in the art the various changes and modifications may be made therein within the scope defined by the appended claims.

What is claimed is:

1. An image forming apparatus comprising:
an endless intermediate transfer belt to a surface of which a toner image is to be transferred;
a drive roller that comes into contact with a reverse surface of the intermediate transfer belt to drive the intermediate transfer belt into rotation;
a transfer roller opposed to the drive roller with the intermediate transfer belt in between to form a transfer nip where a sheet is to be nipped and conveyed;
a static eliminator provided downstream of the transfer nip in a direction of conveyance of the sheet and on the same side as the transfer roller opposite to the drive roller with respect to the direction of conveyance of the sheet;
a first guide provided downstream of the transfer nip in the direction of conveyance of the sheet and including a guide surface located on the same side as the transfer roller with respect to the direction of conveyance of the sheet to extend along the direction of conveyance of the sheet; and
a follower rolling element supported by the first guide to locate downstream of the static eliminator in the direction of conveyance of the sheet and allow for driven rotation,
wherein the follower rolling element is disposed with a center of rotation thereof located on the same side as the transfer roller with respect to an imaginary travel line on which a leading edge of the sheet having passed through the transfer nip is assumed to travel under assumption of absence of the follower rolling element and with a rotating surface of the follower rolling element projecting to the same side as the drive roller beyond the imaginary travel line.

2. The image forming apparatus according to claim 1, wherein a distance from an intersection point between the sheet traveling in the direction of conveyance of the sheet and a perpendicular line from an edge of the static eliminator near the traveling sheet to the traveling sheet to a contact point between a leading edge of the sheet traveling in the direction of conveyance of the sheet and the follower rolling element is shorter than a distance from the leading edge of the sheet traveling in the direction of conveyance of the sheet to an image forming region of the sheet.

3. The image forming apparatus according to claim 1, wherein the follower rolling element is formed to have a wavy circular profile in which a plurality of projections are closely arranged on an outer periphery of the follower rolling element when viewed from an axial direction of the follower rolling element.

4. The image forming apparatus according to claim 1, further comprising an insulating second guide provided to partition a space between the static eliminator and the transfer roller.

5. The image forming apparatus according to claim 1, wherein the follower rolling element is constituted by a cylindrical roller extending in an axial direction of the transfer roller or a plurality of cylindrical rollers arranged spaced-apart on a rotating shaft extending in the axial direction.
